(19) United States
(12) Patent Application Publication
(10) Pub. No.: US 2025/0162951 A1
(43) Pub. Date: May 22, 2025

(54) METAL-CERAMIC SUBSTRATE HAVING DOUBLE BRAZING LAYERS AND METHOD FOR MANUFACTURING THE SAME

(71) Applicant: TONG HSING ELECTRONIC INDUSTRIES, LTD., Taipei City (TW)

(72) Inventors: CHIH-WEI MAO, Taipei City (TW); TSUNG-YING CHANG, Taipei City (TW); CHUNG-HO WEI, Taipei City (TW); MING-YI HSU, Taipei City (TW); CHI-WEN HUANG, Taipei City (TW)

(21) Appl. No.: 18/432,217

(22) Filed: Feb. 5, 2024

(30) Foreign Application Priority Data
Nov. 22, 2023 (TW) 112145072

(51) Int. Cl. C04B 37/02; B23K 35/02; B23K 35/30; B23K 103/00

(52) U.S. Cl. CPC C04B 37/026; B23K 35/025; B23K 35/3006; B23K 35/302; B23K 2103/52; C04B 2237/124; C04B 2237/125; C04B 2237/32; C04B 2237/40

(57) ABSTRACT

A metal-ceramic substrate having double brazing layers and a method for manufacturing the same are provided. The metal-ceramic substrate includes a ceramic substrate layer, a conductive metal layer, and an active metal layer disposed between the ceramic substrate layer and the conductive metal layer. The active metal layer includes a first brazing layer formed from a first active metal solder and an organic dispersion medium, and a second brazing layer formed from a second active metal solder and another organic dispersion medium. The first active metal solder includes silver, copper, and a first active metal. Based on a total weight of the first active metal solder being 100 wt %, an amount of the silver ranges from 10 wt % to 60 wt %. The second active metal solder includes copper and a second active metal, but is without silver.

### CROSS-REFERENCE TO RELATED PATENT APPLICATION

This application claims the benefit of priority to Taiwan Patent Application No. 112145072, filed on Nov. 22, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a metal-ceramic substrate having double brazing layers and a method for manufacturing the same, and more particularly to a metal-ceramic substrate having double brazing layers and a good connection force and a method for manufacturing the same.

### BACKGROUND OF THE DISCLOSURE

With the promotion of energy-saving and carbon reduction policies established in various countries, the global market for electric vehicles is currently booming. In recent years, a plurality of high-voltage (800 volts) vehicle products have been successively launched, which promotes an increasing demand for silicon carbide (SiC) ceramic substrate materials.

However, since requirements on a voltage, a frequency, and an operating temperature of power components of the silicon carbide (SiC) ceramic substrate materials continue to increase, the ceramic substrate materials also need to have better heat dissipation capabilities and reliability.

A direct-bonding-copper (DBC) ceramic substrate that has been widely used is conventionally prepared by eutectic bonding. Hence, there is no bonding material between a copper layer and the ceramic substrate. However, during a high-temperature operation, a large thermal stress is generated due to the difference in thermal expansion coefficients of the copper layer and the ceramic substrate (such as Al₂O₃ or AlN), thereby causing the copper layer to peel off from a surface of the ceramic substrate. Therefore, the conventional direct-bonding-copper ceramic substrate can no longer meet packaging requirements of high temperature, high power, high heat dissipation capability, and high reliability.

Currently, use of active metal brazing (AMB) substrate materials are gradually being substituted with direct-bonding-copper ceramic substrate materials as the mainstream substrate material.

The active metal brazing substrate materials usually contain silver. An amount of the silver in the active metal brazing substrate materials often exceeds 50 wt %, and can even be as high as 70 wt %. However, due to the high amount of the silver, active metal brazing ceramic substrates have high material costs, and the problem of electromigration caused by silver atoms in a solder layer may occur.

Therefore, how to decrease the amount of the silver in the solder layer by adjusting the materials and the structure of the active metal brazing ceramic substrate, so as to overcome the above-mentioned problems, has become one of the important issues to be addressed in the industry.

### SUMMARY OF THE DISCLOSURE

In response to the above-referenced technical inadequacies, the present disclosure provides a metal-ceramic substrate having doubling brazing layers and a method for manufacturing the same.

In order to solve the above-mentioned problems, one of the technical aspects adopted by the present disclosure is to provide a metal-ceramic substrate having doubling brazing layers. The metal-ceramic substrate includes a ceramic substrate layer, an active metal layer, and a conductive metal layer. The active metal layer is disposed between the ceramic substrate layer and the conductive metal layer. The active metal layer includes a first brazing layer and a second brazing layer. The first brazing layer is formed from a first active metal solder and an organic dispersion medium. The first active metal solder includes silver, copper, and a first active metal. Based on a total weight of the first active metal solder being 100 wt %, an amount of the silver ranges from 10 wt % to 60 wt %. The second brazing layer is formed from a second active metal solder and another organic dispersion medium. The second active metal solder includes copper and a second active metal, but is without silver.

In order to solve the above-mentioned problems, another one of the technical aspects adopted by the present disclosure is to provide a method for manufacturing a metal-ceramic substrate having doubling brazing layers. The method includes: coating a first active metal solder paste onto a ceramic substrate, so as to form a first brazing layer onto the ceramic substrate; coating a second active metal solder paste onto the first brazing layer, so as to form a second brazing layer onto the first brazing layer; and disposing a conductive metal layer onto the second brazing layer and implementing a brazing process, so as to obtain a metal-ceramic substrate having double brazing layers. The first active metal solder paste includes a first active metal solder and an organic dispersion medium. The first active metal solder includes silver, copper, and a first active metal. Based on a total weight of the first active metal solder being 100 wt %, an amount of the silver ranges from 10 wt % to 60 wt %. The second active metal solder paste includes a second active metal solder and another organic dispersion medium. The second active metal solder includes copper and a second active metal, but not silver.

Therefore, in the metal-ceramic substrate having the double brazing layers and the method for manufacturing the same provided by the present disclosure, by virtue of “the first active metal solder including silver, copper, and a first active metal,” “based on a total weight of the first active metal solder being 100 wt %, an amount of the silver ranging from 10 wt % to 60 wt %,” and “the second active metal solder including copper and a second active metal, but not including silver,” a connection force between the ceramic substrate layer and the conductive metal layer can be enhanced.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic side view of a metal-ceramic substrate having double brazing layers according to the present disclosure; and

FIG. 2 is a schematic side view of another metal-ceramic substrate having double brazing layers according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

In order to solve the problem of a copper layer peeling off from a ceramic substrate due to differences of thermal expansion coefficients in a direct-bonding-copper ceramic substrate, the present disclosure provides a metal-ceramic substrate having double brazing layers. In the metal-ceramic substrate, usage of a first active metal solder paste and a second active metal solder paste enable the copper layer and the ceramic substrate to have a good connection force. Therefore, the metal-ceramic substrate can be applied in certain package structures that are operated at a high temperature and a high power and require for high reliability. In the present disclosure, the connection force between the copper layer and the ceramic substrate is quantified as a tensile strength of the metal-ceramic substrate for ease of illustration.

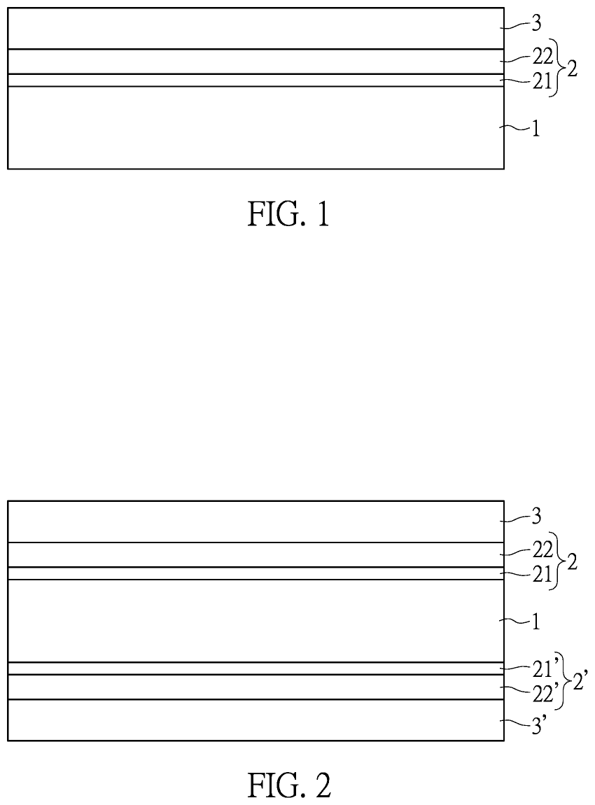

Referring to FIG. 1, the metal-ceramic substrate having the double brazing layers of the present disclosure includes a ceramic substrate layer 1, an active metal layer 2, and a conductive metal layer 3. The active metal layer 2 is disposed between the ceramic substrate layer 1 and the conductive metal layer 3, so as to combine the ceramic substrate layer 1 and the conductive metal layer 3.

The active metal layer 2 includes a first brazing layer 21 and a second brazing layer 22. The first brazing layer 21 contacts the ceramic substrate layer 1. The second brazing layer 22 contacts the conductive metal layer 3.

In FIG. 1, the active metal layer 2 and the conductive metal layer 3 are only disposed on one side of the ceramic substrate layer 1, but the present disclosure is not limited thereto. The active metal layer 2 and the conductive metal layer 3 can be disposed on both sides of the ceramic substrate layer 1 (as shown in FIG. 2).

Referring to FIG. 2, the metal-ceramic substrate having the double brazing layers can have a symmetrical structure. The first brazing layers 21, 21′, the second brazing layers 22, 22′, and the conductive metal layers 3, 3′ are disposed on two opposite sides of the ceramic substrate layer 1, respectively. Accordingly, the metal-ceramic substrate can be used for manufacturing a package structure having double conductive layers.

### Ceramic Substrate Layer

The ceramic substrate layer 1 can be a silicon nitride (SiN) ceramic substrate, a silicon carbide (SiC) ceramic substrate, an aluminum nitride (AlN) ceramic substrate, or an alumina (Al₂O₃) ceramic substrate. The ceramic substrate layer 1 is preferably a ceramic substrate containing silicon, and is more preferably a silicon nitride (SiN) ceramic substrate. A thickness of the ceramic substrate layer 1 can range from 100 μm to 1,000 μm, but the present disclosure is not limited thereto.

### Active Metal Layer

The active metal layer 2 can enhance the connection force between the ceramic substrate layer 1 and the conductive metal layer 3. When the active metal layer 2 is too thin, the connection force between the ceramic substrate layer 1 and the conductive metal layer 3 will decrease. When the active metal layer 2 is too thick, the material costs of the active metal layer 2 can be too high, which is not beneficial for mass production.

A thickness of the active metal layer 2 can be higher than or equal to 6 μm. Preferably, the thickness of the active metal layer 2 can range from 10 μm to 30 μm, such as 12 μm, 14 μm, 16 μm, 18 μm, 20 μm, 22 μm, 24 μm, 26 μm, or 28 μm. More preferably, the thickness of the active metal layer 2 can range from 18 μm to 24 μm.

In addition, a thickness ratio of the first brazing layer 21 to the second brazing layer 22 in the active metal layer 2 can be 1:1 to 1:2, so as to achieve the expected effect with low material costs, but the present disclosure is not limited thereto.

### First Brazing Layer

The first brazing layer 21 is formed from a first active metal solder and an organic dispersion medium.

The first active metal solder includes silver (Ag), copper (Cu), and a first active metal. An amount of the silver (Ag) is higher than an amount of the copper (Cu), and the amount of the copper (Cu) is higher than an amount of the first active metal.

Based on a total weight of the first active metal solder being 100 wt %, the amount of the silver ranges from 10 wt % to 60 wt %. Since the amount of the silver in the first active metal solder is lower than that of the conventional technology, the material costs of the metal-ceramic substrate having the double brazing layers can be decreased, and the probability of electromigration of the silver can also be decreased.

Specifically, based on the total weight of the first active metal solder being 100 wt %, the amount of the silver can be 15 wt %, 20 wt %, 25 wt %, 30 wt %, 35 wt %, 40 wt %, 45 wt %, 50 wt %, or 55 wt %.

During a vacuum sintering process, silver atoms of the first brazing layer 21 can be partially diffused into an interface between the first brazing layer 21 and the second brazing layer 22, and form an alloy with metal atoms of the second brazing layer 22. Therefore, the first brazing layer 21 and the second brazing layer 22 can have a good connection force. For example, the silver of the first brazing layer 21 and the copper of the second brazing layer 22 can form a silver-copper alloy.

In an exemplary embodiment, based on the total weight of the first active metal solder being 100 wt %, the amount of the copper ranges from 30 wt % to 80 wt %, and the amount of the first active metal ranges from 1 wt % to 10 wt %.

Specifically, the amount of the copper can be 35 wt %, 40 wt %, 45 wt %, 50 wt %, 55 wt %, 60 wt %, 65 wt %, 70 wt %, or 75 wt %.

Specifically, the amount of the first active metal can be 2 wt %, 4 wt %, 6 wt %, or 8 wt %. Preferably, based on the total weight of the first active metal solder being 100 wt %, the amount of the first active metal ranges from 2 wt % to 4 wt %.

It should be noted that a melting point of the first active metal is low, such that the first active metal is melted in advance in the vacuum sintering process. The melted first active metal can be filled in small openings of the ceramic substrate layer 1 or the second brazing layer 22, and can even react with the ceramic substrate layer 1 or the second brazing layer 22. On the other hand, the first active metal can also decrease an electrical impedance of the first brazing layer 21.

Specifically, the first active metal can be selected from the group consisting of: titanium (Ti), zirconium (Zr), tantalum (Ta), niobium (Nb), vanadium (V), and hafnium (Hf).

During the vacuum sintering process, the first active metal of the first brazing layer 21 can be partially diffused into an interface between the first brazing layer 21 and the ceramic substrate layer 1, so as to form a metal silicide with silicon atoms of the ceramic substrate layer 1 or form a metal nitride with nitrogen atoms of the ceramic substrate layer 1. Similarly, the first active metal of the first brazing layer 21 can also be partially diffused into the interface between the first brazing layer 21 and the second brazing layer 22 to form an alloy. Therefore, the ceramic substrate layer 1 and the conductive metal layer 3 can have a good connection force.

In an exemplary embodiment, the first active metal is titanium. In the vacuum sintering process, the titanium is diffused into the ceramic substrate layer 1 to form titanium silicide (TiSi), silicon nitride (TiN), or titanium disilicide (TiSi₂) with the silicon atoms or the nitrogen atoms. Moreover, titanium atoms can also be diffused into the second brazing layer 22 and form a titanium-copper alloy with copper atoms of the second brazing layer 22, but the present disclosure is not limited thereto.

### Second Brazing Layer

The second brazing layer 22 is formed from a second active metal solder and another organic dispersion medium. The second brazing layer 22 is disposed between the first brazing layer 21 and the conductive metal layer 3 for preventing electromigration of the silver of the first brazing layer 21 to the conductive metal layer 3.

The second active metal solder includes copper (Cu) and a second active metal, but without silver (Ag). An amount of the copper (Cu) is higher than an amount of the second active metal, and the amount of the copper (Cu) is not higher than 95 wt %.

Specifically, the amount of the copper can be 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, or 90 wt %.

During the vacuum sintering process, the copper atoms of the second brazing layer 22 can be partially diffused into the interface between the first brazing layer 21 and the second brazing layer 22 to form an alloy with metal atoms of the first brazing layer 21. Therefore, the first brazing layer 21 and the second brazing layer 22 can have a good connection force. For example, the copper of the second brazing layer 22 and the silver of the first brazing layer 21 can form the silver-copper alloy.

In an exemplary embodiment, based on the total weight of the second active metal solder being 100 wt %, the amount of the second active metal ranges from 1 wt % to 10 wt %.

Specifically, the amount of the second active metal can be 2 wt %, 4 wt %, 6 wt %, or 8 wt %. Preferably, the amount of the second active metal ranges from 2 wt % to 4 wt %.

It should be noted that a melting point of the second active metal is low, such that the second active metal is melted in advance in the vacuum sintering process. The melted second active metal can be filled in small openings of the first brazing layer 21 or the conductive metal layer 3, and can even react with the first brazing layer 21 or the conductive metal layer 3. On the other hand, the second active metal can also decrease an electrical impedance of the second brazing layer 22.

Specifically, the second active metal can be selected from the group consisting of: titanium (Ti), zirconium (Zr), tantalum (Ta), niobium (Nb), vanadium (V), and hafnium (Hf).

During the vacuum sintering process, the second active metal of the second brazing layer 22 can be partially diffused into the interface between the first brazing layer 21 and the second brazing layer 22, and forms an alloy with the metal atoms of the first brazing layer 21. The second active metal of the second brazing layer 22 can also be partially diffused into an interface between the second brazing layer 22 and the conductive metal layer 3, and forms an alloy with metal atoms of the conductive metal layer 3. Accordingly, the ceramic substrate layer 1 and the conductive metal layer 3 can have a good connection force.

In an exemplary embodiment, the second active metal is titanium. In the vacuum sintering process, the titanium atoms are diffused into the first brazing layer 21 to form a titanium-copper alloy with copper atoms of the first brazing layer 21. Moreover, the titanium atoms can also be diffused into the conductive metal layer 3 and form a titanium-copper alloy with copper atoms of the conductive metal layer 3, but the present disclosure is not limited thereto.

### Conductive Metal Layer

The conductive metal layer 3 can be disposed on the ceramic substrate layer 1 via the active metal layer 2. Specifically, the conductive metal layer 3 can be a copper foil, an aluminum foil, or a copper-aluminum alloy foil. In an exemplary embodiment, the conductive metal layer 3 is a copper foil.

A thickness of the conductive metal layer 3 can range from 50 μm to 1,200 μm. Preferably, the thickness of the conductive metal layer 3 can range from 200 μm to 800 μm, but the present disclosure is not limited thereto.

### Method for Manufacturing Metal-Ceramic Substrate Having Double Brazing Layers

In step S1, the first active metal solder paste is prepared. The first active metal solder paste is used to form the first brazing layer 21. The first active metal solder paste includes the first active metal solder and the organic dispersion medium mentioned above.

The first active metal solder includes the above-mentioned silver, copper, and first active metal. In an exemplary embodiment, the first active metal solder is a combination of a silver powder, a copper powder, and a first active metal powder. In another embodiment, the first active metal solder can include a silver-copper alloy powder and the first active metal powder, and can further selectively include at least one of the silver powder and the copper powder.

As mentioned above, based on the total weight of the first active metal solder being 100 wt %, the amount of the silver ranges from 10 wt % to 60 wt %. A weight ratio of the silver to the copper is higher than 1. A weight ratio of the copper to the first active metal is higher than 1.

The organic dispersion medium can help disperse the first active metal solder, and can help solidify the first active metal solder paste to form the first brazing layer 21. Specifically, the organic dispersion medium includes a paste agent, an organic solvent, and a thixotropic agent. Based on a total weight of the organic dispersion medium being 100 wt %, an amount of the paste agent ranges from 20 wt % to 30 wt %, an amount of the organic solvent ranges from 50 wt % to 70 wt %, and an amount of the thixotropic agent ranges from 1 wt % to 5 wt %.

For example, the paste agent can be selected from the group consisting of silicone oil, white oil, polyvinyl alcohol, acrylic resin, nitrocellulose, ethylcellulose, dimethyl phthalate, and carboxymethylcellulose. Preferably, the paste agent is ethylcellulose.

The organic solvent can be selected from the group consisting of ethylene glycol butyl ether acetate, diethylene glycol, triethanolamine, butyl cellosolve (ethylene glycol monobutyl ether), tert-butyl alcohol, N,N-dimethylformamide, terpineol, and nonylphenol polyglycol ether. Preferably, the organic solvent can be terpineol or ethylene glycol butyl ether acetate.

The thixotropic agent solvent can be selected from the group consisting of polyamide wax, hydrogenated castor oil, and polyurea. Preferably, the thixotropic agent is polyamide wax.

The first active metal solder and the organic dispersion medium are mixed at a weight ratio of 70% to 95%: 5% to 30%, so that the first active metal solder paste is formed to have a viscosity ranging from 50 mPa·s to 300 mPa·s. Preferably, the weight ratio of the first active metal solder to the organic dispersion medium is 75% to 90%: 10% to 25%.

However, the present disclosure is not limited to the examples mentioned above, and as long as the first active metal solder and the organic solvent can be prepared into the first active metal solder paste that has a suitable viscosity for being coated onto the ceramic substrate layer 1 and forming the first brazing layer 21, such a process or configuration for achieving the same is considered to be within the spirit and scope of the present disclosure.

In step S2, the first active metal solder paste can be coated onto the ceramic substrate layer 1 by screen printing, and dried at a temperature ranging from 90° C. to 110° C. for 5 minutes to 15 minutes. In this way, most of the organic solvent in the first active metal solder paste will volatilize, thereby forming the first brazing layer 21.

In step S3, the second active metal solder paste is prepared. The second active metal solder paste is used to form the second brazing layer 22. The second active metal solder paste includes the second active metal solder and the organic dispersion medium mentioned above.

The second active metal solder includes the above-mentioned copper and second active metal. In an exemplary embodiment, the second active metal solder is a combination of a copper powder and a second active metal powder. As mentioned above, the amount of the copper in the second active metal solder is not lower than 85 wt %, and is higher than an amount of the second active metal powder in the second active metal solder (based on the total weight of the second active metal solder being 100 wt %).

The organic dispersion medium can help disperse the second active metal solder, and can help solidify the second active metal solder paste to form the second brazing layer 22. Specifically, the organic dispersion medium includes the above-mentioned paste agent, organic solvent, and thixotropic agent, and thus will not be reiterated herein.

The second active metal solder and the organic dispersion medium are mixed at a weight ratio of 70% to 95%: 5% to 30%, so that the second active metal solder paste is formed to have a viscosity ranging from 50 mPa·s to 300 mPa·s. Preferably, the weight ratio of the second active metal solder to the organic dispersion medium is 75% to 90%: 10% to 25%.

However, the present disclosure is not limited to the examples mentioned above, and as long as the second active metal solder and the organic solvent can be prepared into the second active metal solder paste that has a suitable viscosity for being coated onto the first brazing layer 21 and forming the second brazing layer 22, such a process or configuration for achieving the same is considered to be within the spirit and scope of the present disclosure.

In step S4, the second active metal solder paste can be coated onto the first brazing layer 21 by screen printing, and dried at a temperature ranging from 90° C. to 110° C. for 5 minutes to 15 minutes. In this way, most of the organic solvent in the second active metal solder paste will volatilize, thereby forming the second brazing layer 22.

In step S5, the conductive metal layer 3 is disposed onto the second brazing layer 22, and then a brazing process is implemented to fix the conductive metal layer 3 onto the ceramic substrate layer 1.

The brazing process includes a first heat treatment stage and a second heat treatment stage, which can be implemented in a vacuum environment. A processing temperature of the first heat treatment stage is not higher than 500° C. A processing temperature of the second heat treatment stage ranges from 900° C. to 1,100° C. (i.e., a brazing temperature). The processing temperature of the second heat treatment stage is higher than the processing temperature of the first heat treatment stage.

Specifically, in the first heat treatment stage, the processing temperature ranges from 300° C. to 500° C., and a processing period ranges from 30 minutes to 60 minutes. In the second heat treatment stage, the processing temperature ranges from 900° C. to 960° C., and a processing period ranges from 60 minutes to 240 minutes. In addition, temperature rising rates of the heat treatment stages mentioned above can range from 5° C./min to 30° C./min, and temperature descending rates of the heat treatment stages mentioned above can range from 2° C./min to 30° C./min.

During the brazing process, the organic dispersion medium is partially vaporized. A surface of the ceramic substrate layer 1 is wet by the first active metal, and the ceramic substrate layer 1 reacts with the first active metal, so as to enhance a connection force between the active metal layer 2 and the ceramic substrate layer 1. Moreover, the second active metal and the metal atoms of the conductive metal layer 3 undergo a micron-scaled eutectic reaction at the interface between the active metal layer 2 and the conductive metal layer 3, thereby forming a strong eutectic structure. Hence, the active metal layer 2 and the conductive metal layer 3 are tightly combined.

### Tests 1 to 6

In order to compare the influences of the brazing temperature and components of the first brazing layer 21 and the second brazing layer 22 on the tensile strength of the metal-ceramic substrate, metal-ceramic substrates of Test 1 to Test 6 are prepared by steps S1 to S5 mentioned above.

In the metal-ceramic substrates of Test 1 to Test 6, the ceramic substrate layer 1 is a silicon nitride ceramic substrate, a thickness of the first active metal layer 21 is 12 μm, a thickness of the second active metal layer 22 is 12 μm, and the conductive metal layer 3 is a copper layer.

During preparation of the first active metal solder paste, ethylcellulose is used as the paste agent, ethylene glycol butyl acetate is used as the organic solvent, and polyamide wax is used as the thixotropic agent. Based on the total weight of the organic dispersion medium being 100 wt %, the amount of the paste agent is 25 wt %, the amount of the organic solvent is 60 wt %, and the amount of the thixotropic agent is 2.5 wt %.

During preparation of the second active metal solder paste, ethylcellulose is used as the paste agent, ethylene glycol butyl acetate is used as the organic solvent, and polyamide wax is used as the thixotropic agent. Based on the total weight of the organic dispersion medium being 100 wt %, the amount of the paste agent is 25 wt %, the amount of the organic solvent is 60 wt %, and the amount of the thixotropic agent is 2.5 wt %.

The specific components of the first brazing layer 21 and the second brazing layer 22, and the specific brazing temperature are listed in Table 1. The tensile strength of the metal-ceramic substrate is measured at 25° C. according to the JIS-C-6481 standard, and results thereof are listed in Table 1.

TABLE 1

| | Components of | Components of | | |
|---|---|---|---|---|
| | first brazing | second brazing | Brazing | Tensile |
| | layer | layer | temperature | strength |
| Test 1 | Copper-titanium | Silver-copper- | 915° C. | N/A |
| | | titanium | | |
| Test 2 | Silver-copper- | Copper-titanium | 915° C. | >200 |
| | titanium | | | N/cm |
| Test 3 | Copper-titanium | Silver-copper- | 950° C. | <50 |
| | | titanium | | N/cm |
| Test 4 | Silver-copper- | Copper-titanium | 950° C. | >200 |
| | titanium | | | N/cm |
| Test 5 | Silver-copper- | Silver-copper- | 915° C. | 100 to 200 |
| | titanium | titanium | | N/cm |
| Test 6 | Silver-copper- | Silver-copper- | 950° C. | 100 to 200 |
| | titanium | titanium | | N/cm |

According to the results in Table 1, when the amount of the silver in the first brazing layer 21 ranges from 10 wt % to 60 wt %, and the second brazing layer 22 does not include the silver, the tensile strength of the metal-ceramic substrate having the double brazing layers can be higher than 200 N/cm. Even if the brazing temperature is low (ranging from 900° C. to 960° C.), the metal-ceramic substrate having the double brazing layers can still have the expected tensile strength.

### Beneficial Effects of the Embodiment

In conclusion, in the metal-ceramic substrate having the double brazing layers and the method for manufacturing the same provided by the present disclosure, by virtue of “the first active metal solder including silver, copper, and a first active metal,” “based on a total weight of the first active metal solder being 100 wt %, an amount of the silver ranging from 10 wt % to 60 wt %,” and “the second active metal solder including copper and a second active metal, but not including silver,” a connection force between the ceramic substrate layer and the conductive metal layer can be enhanced.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A metal-ceramic substrate having double brazing layers, comprising:
a ceramic substrate layer;
an active metal layer including:
a first brazing layer formed from a first active metal solder and an organic dispersion medium, wherein the first active metal solder includes silver, copper, and a first active metal; wherein, based on a total weight of the first active metal solder being 100 wt %, an amount of the silver ranges from 10 wt % to 60 wt %; and
a second brazing layer formed from a second active metal solder and another organic dispersion medium, wherein the second active metal solder includes copper and a second active metal, but not silver; and
a conductive metal layer;
wherein the active metal layer is disposed between the ceramic substrate layer and the conductive metal layer, the first brazing layer contacts the ceramic substrate layer, and the second brazing layer contacts the conductive metal layer.

2. The metal-ceramic substrate according to claim 1, wherein, in the first active metal solder, a weight ratio of the silver to the copper is higher than 1.

3. The metal-ceramic substrate according to claim 1, wherein, based on the total weight of the first active metal solder being 100 wt %, an amount of the first active metal ranges from 2 wt % to 4 wt %.

4. The metal-ceramic substrate according to claim 1, wherein, based on a total weight of the second active metal solder being 100 wt %, an amount of the copper is not higher than 95 wt %.

5. The metal-ceramic substrate according to claim 1, wherein a thickness ratio of the first brazing layer to the second brazing layer ranges from 1:1 to 1:2.

6. The metal-ceramic substrate according to claim 1, wherein silver atoms of the first brazing layer are partially diffused into an interface between the first brazing layer and the second brazing layer, and form a silver-copper alloy.

7. The metal-ceramic substrate according to claim 1, wherein the first active metal of the first brazing layer is partially diffused into an interface between the first brazing layer and the ceramic substrate layer, and forms an alloy.

8. The metal-ceramic substrate according to claim 1, wherein the second active metal of the second brazing layer is partially diffused into an interface between the second brazing layer and the first brazing layer, and forms an alloy.

9. The metal-ceramic substrate according to claim 1, wherein the second active metal of the second brazing layer is partially diffused into an interface between the second brazing layer and the conductive metal layer, and forms an alloy.

10. A method for manufacturing a metal-ceramic substrate having double brazing layers, comprising:
coating a first active metal solder paste onto a ceramic substrate, so as to form a first brazing layer onto the ceramic substrate; wherein the first active metal solder paste includes a first active metal solder and an organic dispersion medium, and the first active metal solder includes silver, copper, and a first active metal; wherein, based on a total weight of the first active metal solder being 100 wt %, an amount of the silver ranges from 10 wt % to 60 wt %;
coating a second active metal solder paste onto the first brazing layer, so as to form a second brazing layer onto the first brazing layer; wherein the second active metal solder paste includes a second active metal solder and another organic dispersion medium, and the second active metal solder includes copper and a second active metal, but not silver; and
disposing a conductive metal layer onto the second brazing layer and implementing a brazing process, so as to obtain the metal-ceramic substrate having the double brazing layers.
